(19) United States
(12) Patent Application Publication
(10) Pub. No.: US 2026/0367020 A1
(43) Pub. Date: Nov. 19, 2026

(54) APPARATUS AND METHOD FOR IMPROVED ELECTRON BEAM INSPECTION WITH PROGRAMMABLE ANGLE AND ENERGY DETECTION

(71) Applicant: Taiwan Semiconductor Manufacturing Company, Ltd., Hsinchu (TW)

(72) Inventors: Kuang-Shing CHEN, Hsinchu (TW); Yu-Hsiang CHENG, Taipei (TW); Yu-Tang HUANG, Kaohsiung (TW); Cheng-Ying CHAN, Hsinchu (TW); Ding-Shiun TU, Hsinchu (TW); Chien-Huei CHEN, Kaohsiung (TW); Xiaomeng CHEN, Baoshan (TW)

(73) Assignee: Taiwan Semiconductor Manufacturing Company, Ltd., Hsinchu (TW)

(21) Appl. No.: 19/754,053

(22) Filed: Jul. 24, 2026

Related U.S. Application Data
(63) Continuation of application No. 19/015,200, filed on Jan. 9, 2025.
(60) Provisional application No. 63/689,293, filed on Aug. 30, 2024.

(51) Int. Cl. G01N 23/20008; G01N 23/203

(52) U.S. Cl. CPC G01N 23/20008; G01N 23/203; G01N 2223/053; G01N 2223/102; G01N 2223/501; G01N 2223/504; G01N 2223/646

(57) ABSTRACT

An electron detector includes a detector body having a detector surface with an annular geometry and a central aperture configured to allow a focused electron beam to pass through the detector body toward a sample. The detector surface is configured to face the sample, and a plurality of detector devices are located on the detector surface. Each of the plurality of detector devices is configured to generate an electrical signal in response to interaction with an electron backscattered from the sample. According to various embodiments, the plurality of detector devices includes at least a first two detector devices separated from one another along a radial direction along the detector surface and at least a second two detector devices separated from one another along an angular direction along the detector surface. The detector devices are configured to determine both a polar incidence angle and an azimuthal incidence angle of detected electrons.

### CROSS-REFERENCE TO RELATED APPLICATION

This application is a continuation of U.S. patent application Ser. No. 19/015,200, filed on Jan. 9, 2025, which claims priority to U.S. Provisional Patent Application No. 63/689,293, filed on Aug. 30, 2024, the disclosure of each of which is incorporated herein by reference in its entirety.

### BACKGROUND

Extreme ultraviolet (EUV) lithography is an innovative technology used in semiconductor manufacturing to produce integrated circuits having extremely small and complex patterns. By employing a wavelength of approximately 13.5 nm, EUV lithography enables the creation of features at the nanometer scale, which is desirable for advancing the continued size reduction of semiconductor devices. As the patterns become increasingly intricate, the need for high-resolution inspection systems to accurately detect and address defects becomes more pronounced. Electron beam inspection systems, when utilized in conjunction with EUV lithography, offer a promising approach for high-resolution inspection and defect detection. These systems provide the capability for analyzing intricate patterns characteristic of EUV lithography, enabling rapid and precise identification of nanometer-scale defects. Such systems thus facilitate improved yield and performance in semiconductor devices fabricated using EUV technology.

### BRIEF DESCRIPTION OF THE DRAWING

The present disclosure is best understood from the following detailed description when read with reference to the accompanying figures. It is emphasized that, following the standard practice in the industry, various features are not drawn to scale and are used for illustration purposes only. In this regard, the dimensions of the various features may be arbitrarily increased or reduced for clarity of discussion.

FIG. 1 is a vertical cross-sectional view of an EUV lithography system, according to various embodiments.

FIG. 2 is a three-dimensional perspective view of an electron-beam inspection system, according to various embodiments.

FIG. 3A is an axial view of an electron detector that is configured to determine polar incidence angles of detected electrons, according to various embodiments.

FIG. 3B is a simplified schematic view of an electron beam inspection system including the electron detector of FIG. 3A, according to various embodiments.

FIG. 4 is an axial view of an electron detector configured to determine polar incidence angles and azimuthal incidence angles of detected electrons, according to various embodiments.

FIG. 5A is an axial view of a detector configured to determine polar incidence angles and azimuthal incidence angles of detected electrons, according to various embodiments.

FIG. 5B is an axial view of a detector configured to determine polar incidence angles and azimuthal incidence angles of detected electrons, according to various embodiments.

FIG. 6A is a top view of a semiconductor structure having a defect, according to various embodiments.

FIG. 6B is an energy-angle mapping of intensities of detected electrons, according to various embodiments.

FIG. 7A is an energy-angle mapping of intensities of detected electrons, according to various embodiments.

FIG. 7B is an energy-angle mapping of intensities of detected electrons, according to various embodiments.

FIG. 7C is an energy-angle mapping of intensities of detected electrons, according to various embodiments.

FIG. 7D is an energy-angle mapping of intensities of detected electrons, according to various embodiments.

FIG. 8 is a flowchart illustrating operations of a computer-implemented method of controlling a defect detection system, according to various embodiments.

FIG. 9A illustrates a computer controller for performing the method of FIG. 8, according to various embodiments.

FIG. 9B is a schematic layout of components of the computer controller of FIG. 9A, according to various embodiments.

### DETAILED DESCRIPTION

The following disclosure provides many different embodiments, or examples, for implementing different features of the provided subject matter. Specific examples of components and arrangements are described below to simplify this disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, this disclosure may repeat reference numerals and/or letters in the various examples. This repetition is for simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. In addition, the term “made of” may mean either “including” or “consisting of.” In this disclosure, the phrase “one of A, B and C” means “A, B and/or C” (A, B, C, A and B, A and C, B and C, or A, B and C), and does not mean one element from A, one element from B and one element from C, unless otherwise described.

Disclosed embodiments are advantageous by providing systems and methods of detecting backscattered electrons with energy and angular resolution such that both polar incidence angles and azimuthal incidence angles of backscattered electrons are determined. Such systems provide the ability to generate energy-angle mappings that exhibit localized features that are characteristic of particular types of defects. Thus, embodiment systems and methods can provide information in addition to that obtained from standard techniques used to characterize defects. Numerical simulation results indicate that such energy-angle mappings can provide useful information about deep defects.

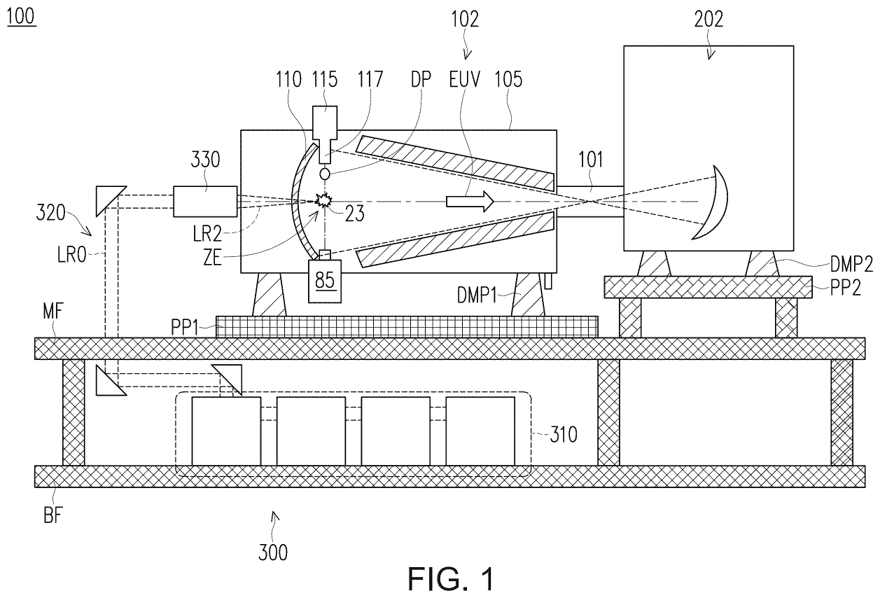

FIG. 1 is a vertical cross-sectional view of an extreme ultraviolet (EUV) lithography system 100 with an EUV radiation source 102, according to various embodiments. The EUV lithography system 100 further includes an exposure device 202, such as a scanner, and an excitation laser source 300. As shown in FIG. 1, in some embodiments, the EUV radiation source 102 and the exposure device 202 are installed on a main floor MF of a clean room, while the excitation laser source 300 is installed in a base floor BF located under the main floor. Each of the EUV radiation source 102 and the exposure device 202 are placed over pedestal plates PP1 and PP2 via dampers DMP1 and DMP2, respectively. The EUV radiation source 102 and the exposure device 202 are coupled to one another by a coupling mechanism, which includes a focusing unit 101.

The EUV lithography system 100 is designed to expose a resist layer, formed over a substrate, to EUV radiation. The resist layer is a material sensitive to the EUV radiation. The EUV lithography system 100 employs the EUV radiation source 102 to generate EUV radiation, such as EUV radiation having a wavelength ranging between about 1 nm and about 50 nm. In an example embodiment, the EUV radiation source 102 generates EUV radiation with a peak wavelength that is approximately 13.5 nm. In this embodiment, the EUV radiation source 102 utilizes a mechanism of laser-produced plasma to generate the EUV radiation.

The exposure device 202 includes various reflective optical components, such as convex mirrors, concave mirrors, and flat mirrors (not shown). The exposure device 202 further includes a mask-holding mechanism including a mask stage, and a wafer-holding mechanism (e.g., a substrate-holding mechanism). The EUV radiation generated by the EUV radiation source 102 is guided by the reflective optical components onto a mask secured on the mask stage (both not shown in FIG. 1). Because gas molecules absorb EUV radiation, the EUV lithography system 100 is maintained in a vacuum or a low-pressure environment to avoid EUV intensity loss.

In some embodiments, a reticle is introduced into the exposure device 202, which operates under vacuum conditions. The reticle is positioned above a substrate coated with a photoresist layer, and a pellicle is mounted on the reticle. The exposure device 202 includes a projection optics module that images the pattern of the mask onto a semiconductor substrate, which has a resist coated thereon and which is secured on a substrate stage of the exposure device 202. The projection optics module generally includes reflective optics. The EUV radiation directed from the mask, carrying the image of the pattern defined on the mask, is collected by the projection optics module, thereby forming an image on the resist.

In various embodiments, the semiconductor substrate is a semiconductor wafer, such as a silicon wafer or other type of wafer to be patterned. The semiconductor substrate is coated with a resist layer that is sensitive to the EUV radiation. Various components, including those described above, are integrated and are operable to perform lithography exposure processes. The EUV lithography system 100 may further include other modules or be integrated with (or be coupled with) other modules.

As shown in FIG. 1, the EUV radiation source 102 includes a droplet generator 115 and a laser-produced plasma collector mirror 110, enclosed by a chamber 105. The droplet generator 115 generates a plurality of target droplets DP, which are supplied into the chamber 105 through a nozzle 117. In some embodiments, the target droplets DP are Sn, Li, or an alloy of Sn and Li. In some embodiments, the target droplets DP each have a diameter in a range from about 10 microns to about 102 microns. For example, in an embodiment, the target droplets DP are Sn droplets, each having a diameter of about 10 microns, about 25 microns, about 50 microns, or any diameter between these values.

The excitation laser beam LR2 generated by the excitation laser source 300 is a pulsed beam. The laser pulses of laser beam LR2 are generated by the excitation laser source 300. The excitation laser source 300 includes a laser generator 310, laser guide optics 320, and a focusing apparatus 330. In some embodiments, the laser generator 310 includes a carbon dioxide (CO₂) or a neodymium-doped yttrium aluminum garnet (Nd: YAG) laser source with a wavelength in the infrared region of the electromagnetic spectrum. For example, the laser source 310 has a wavelength of 9.4 microns or 10.6 microns in an embodiment. The laser beam LR0 generated by the excitation laser source 300 is guided by the laser guide optics 320 and focused, by the focusing apparatus 330, into the excitation laser beam LR2 that is introduced into the EUV radiation source 102. Other than to CO₂ and Nd: YAG lasers, in some embodiments, the laser beam LR2 is generated by a gas laser including an excimer gas discharge laser, helium-neon laser, nitrogen laser, transversely excited atmospheric (TEA) laser, argon ion laser, copper vapor laser, KrF laser or ArF laser; or a solid state laser including Nd: glass laser, ytterbium-doped glasses or ceramics laser, or ruby laser.

The laser beam LR2 is directed through windows or lenses (not shown) into the zone of excitation ZE. The windows or lenses may be made of a suitable material that is substantially transparent to the laser beams. The generation of the laser pulses is synchronized with the ejection of the target droplets DP through the nozzle 117. As the target droplets move through the excitation zone, the pre-pulses heat the target droplets and transform them into low-density target plumes. A delay between the pre-pulse and the main pulse is controlled to allow the target plume to form and expand to an optimal size and geometry. In various embodiments, the pre-pulse and the main pulse have the same pulse duration and peak power. When the main pulse heats the target plume, a high-temperature plasma is generated. The plasma emits EUV radiation, which is collected by the collector mirror 110. The collector mirror 110, which is configured as an EUV collector mirror, further reflects, and focuses the EUV radiation which may be provided to the exposure device 202. A droplet DP that does not interact with the laser pulses is captured by the droplet catcher 85.

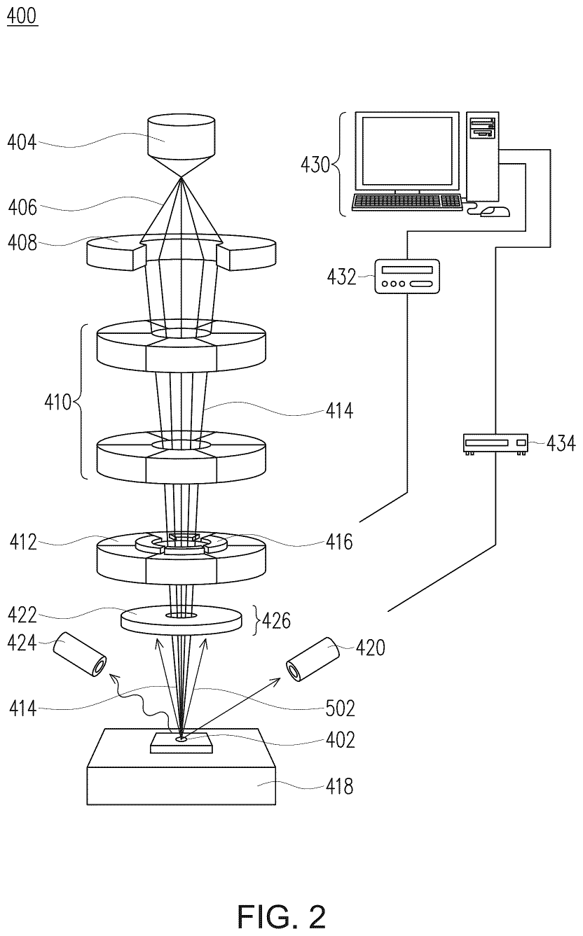

FIG. 2 is a three-dimensional perspective view of an electron-beam inspection system 400, according to various embodiments. The electron beam inspection system 400 includes a plurality of components designed to generate, focus, and detect electron beams (406, 414) for high-resolution imaging of a sample 402. The electron beam inspection system 400, includes an electron source 404 that generates a primary beam of electrons 406, an anode 408, condenser lenses 410, an objective lens 412, scanning coils 416, a motorized stage 418, a secondary electron detector 420, a backscattering detector 422, and an x-ray detector 424. Each of these components is described in detail below.

The primary beam of electrons 406, generated by the electron source 404, is accelerated toward the sample 402 by the anode 408, imparting the necessary energy for interaction with the sample 402 surface. Condenser lenses 410, positioned between the electron source 404 and the objective lens 412, focus the primary beam of electrons 406 to generate a focused electron beam 414 and control its intensity and diameter. The objective lens 412, including scanning coils 416, enables precise positioning and scanning of the electron beam 414 over a surface of the sample 402. The motorized stage 418 holds the sample 402 securely and allows for precise movement during the scanning process.

As the electron beam 414 interacts with the sample 402, different types of signals are produced, which are detected by the various detectors (420, 422, 424). The secondary electron detector 420 captures low-energy secondary electrons, providing high-resolution images with surface detail. In contrast, the backscattering detector 422 collects backscattered electrons, offering contrast based on compositional differences (i.e., differences in atomic number of materials) within the sample 402. Additionally, an x-ray detector 424 measures characteristic x-rays emitted by the sample 402, facilitating elemental analysis. Together, these components enable the electron beam inspection system 400 to produce detailed images and provide compositional information about the sample 402.

The incorporation of an electron-beam inspection system 400 into the EUV lithography system 100 follows different approaches in respective embodiments, depending on the specific design and requirements of the semiconductor manufacturing line. For example, in some embodiments, the electron-beam inspection system 400 is not installed in the same vacuum chamber as the EUV patterning module but rather in a separate inspection module. However, in such embodiments, the process is configured to transfer a wafer between the EUV lithography tool 100 and the electron-beam inspection system 400, either maintaining vacuum or allowing for controlled venting.

According to various embodiments, the wafer (e.g., the sample 402) is transferred from the EUV exposure device 202 to the electron-beam inspection system 400 without breaking vacuum. This configuration is advantageous because it minimizes the risk of contamination, which is particularly important in EUV lithography, where even small particles can significantly impact yield due to the fine feature sizes being patterned. A vacuum-based wafer handling system serves to avoid introducing contaminants during the transfer process. This can be achieved by integrating vacuum-compatible robotic handling systems (not shown) that shuttle wafers between the EUV lithography tool 100 and the electron-beam inspection system 400 through vacuum-tight load locks.

Alternatively, in some embodiments, the wafer is transferred to the electron beam inspection system 400 with a controlled venting process, where the vacuum is broken temporarily but under highly controlled conditions to prevent contamination. In such cases, the chambers are purged with clean gases, and the time spent outside of vacuum is minimized to reduce the possibility of particulate or chemical contamination. The decision on whether to maintain vacuum or allow for controlled venting during wafer transfer depends on the specific design goals of the semiconductor fabrication line, the criticality of contamination control, and throughput considerations. Maintaining vacuum throughout the process may be implemented in high-end manufacturing environments, as it enhances cleanliness and reduces the potential for yield loss due to defects introduced during handling. However, both configurations can be successfully implemented, with the electron beam inspection system 400 integrated as an important tool for defect detection in the EUV lithography process.

According to an embodiment, the electron source 404 generates a primary electron beam 406 that serves as the initiating beam for the inspection process. The electron source 404, in this embodiment, is a thermionic or field-emission gun, depending on the required beam properties. The primary electron beam 406 generated by the electron source 404 is accelerated toward the sample 402 by an anode 408, positioned downstream of the electron source 404. The anode 408 applies a potential difference to the electron source 404, thereby imparting the necessary energy to the electron beam 414 to promote interactions with the sample's surface.

Following the anode 408, the electron beam 414 passes through a series of condenser lenses 410, which focus the electron beam 414 and control its intensity and diameter. The condenser lenses 410 are arranged to produce a precise and narrow electron beam 414 that remains well-focused as it approaches the sample 402. This focused electron beam 414 enables high-resolution imaging of the sample surface and enhances the beam's interaction efficiency.

Downstream from the condenser lenses 410, according to an embodiment, the objective lens 412, which includes scanning coils 416, directs the electron beam 414 onto the sample 402 and enables scanning of the beam over the sample's 402 surface. The objective lens 412 further refines the focus of the electron beam 414 to a precise spot on the sample 402, facilitating high-resolution imaging. The scanning coils 416, integrated within the objective lens 412, allow for precise, controlled scanning by deflecting the electron beam 414 in a raster pattern, enabling comprehensive surface inspection and mapping.

According to an embodiment, the backscattering detector 422 includes a detector body 426 having an annular shape and includes semiconductor devices (not shown) configured to detect backscattered electrons 502. The annular configuration of the backscattering detector 422 surrounds the optical axis of the electron beam 414, allowing it to capture electrons 502 backscattered from the sample 402 surface across a broad angular range. This annular positioning provides optimal coverage for detecting electrons 502 that scatter at high angles relative to the incident beam 414, enhancing the detector's ability to capture signal variations based on the atomic number and composition of the sample 402.

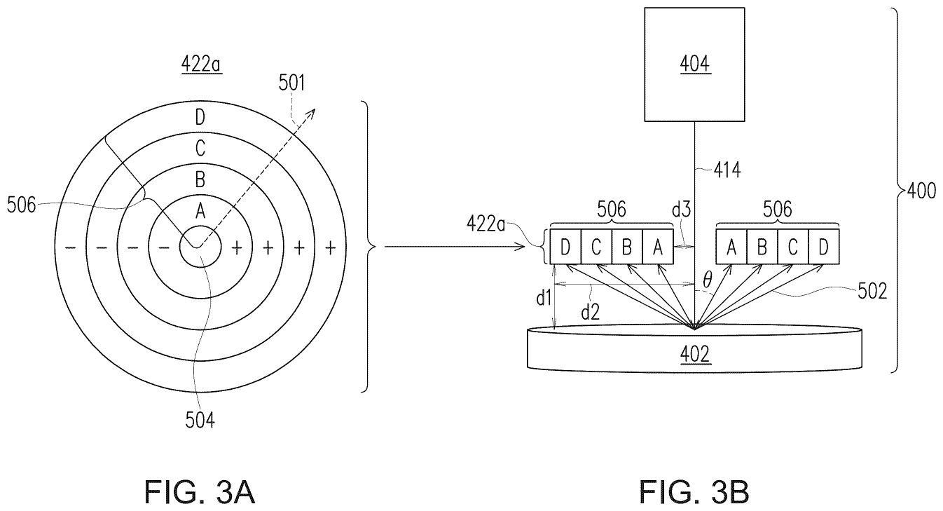

The semiconductor devices within the annular backscattering detector 422 are strategically arranged to efficiently detect the backscattered electrons, as described in greater detail with reference to FIGS. 3A to 5B, below. These semiconductor devices generate an electrical signal in response to the energy transferred from incoming electrons. By arranging multiple semiconductor elements around the detector's annular perimeter, the backscattering detector 422 can achieve both high sensitivity and spatial resolution, which are advantageous for producing contrast in images based on variations in composition across the sample surface 402.

The annular shape and semiconductor-based detection capability of the backscattering detector 422 allow it to provide detailed compositional information, facilitating material characterization and analysis of structural features within the sample 402. This configuration further enables the electron beam inspection system 400 to produce enhanced images with compositional contrast, supporting more precise inspection and analysis.

According to certain embodiments, the semiconductor devices suitable for detecting backscattered electrons in the backscattering detector 422 include silicon-based photodiodes, avalanche photodiodes (APDs), and PIN diodes. These semiconductor devices are advantageous for electron detection due to their high sensitivity, fast response times, and capability to operate under low-noise conditions, which are beneficial for detecting subtle variations in backscattered electron intensity.

In one embodiment, a silicon-based photodiode is provided as a detector, where the interaction of backscattered electrons with the semiconductor material generates electron-hole pairs. This interaction produces an electrical signal that is proportional to the electron energy absorbed, enabling the photodiode to effectively capture backscattered electrons with minimal signal degradation.

In another embodiment, avalanche photodiodes (APDs) are provided as suitable semiconductor devices. APDs are designed to operate with internal gain through an avalanche multiplication process, where a single high-energy electron interaction can initiate a cascade of electron-hole pairs, amplifying the signal. Avalanche amplification is advantageous for detecting low-intensity backscattered electrons, because the amplification increases the detector's sensitivity and enhances the accuracy of material contrast in imaging.

Additionally, in a further embodiment, PIN diodes, structured with p-type, intrinsic, and n-type layers, are provided for backscattered electron detection. The intrinsic region provides a wider depletion region, increasing the electron absorption efficiency and thus enhancing sensitivity to backscattered electrons. The design of PIN diodes allows for improved charge collection efficiency, making them suitable for detecting both high and low-energy backscattered electrons with high precision.

The above-described semiconductor devices, whether silicon-based photodiodes, avalanche photodiodes, or PIN diodes, contribute to the capability of the backscattering detector 422 to accurately detect backscattered electrons and provide compositional contrast information in the electron beam inspection system 400. According to an embodiment, the electron beam inspection system 400 further includes a computer controller 430, a scan generator 432, and a signal amplifier 434. These components are configured to control the operation of the inspection tool 400, manage scanning patterns, and process detected signals to generate high-resolution images with compositional information. Each component is described in detail below.

According to an embodiment, the computer controller 430 is configured to coordinate and manage the overall operation of the electron beam inspection system 400. The computer controller 430 includes a processor and associated memory for executing instructions related to beam control, scanning parameters, image processing, and data analysis. The computer controller 430 communicates with various subsystems, including the electron source 404, detectors, scan generator 432, and signal amplifier 434, to provide precise control over the beam's path, scanning resolution, and data acquisition timing. Additionally, the computer controller 430 processes the output from the detectors and can apply image-processing algorithms to enhance detail and contrast in the resulting images.

According to another embodiment, the scan generator 432 includes scanning patterns that direct the electron beam 414 over the sample surface 402 in a raster or other predetermined pattern. The scan generator 432 provides control signals to the scanning coils 416 within the objective lens 412, precisely adjusting the beam's position to achieve the desired scan coverage and resolution. The scan generator 432 thus enables detailed surface inspection and guidance of interaction between the electron beam 414 and the sample 402, facilitating accurate data acquisition and image generation.

In addition, according to a further embodiment, a signal amplifier 434 is provided to amplify signals received from the detectors, including the secondary electron detector 420, backscattering detector 422, and x-ray detector 424. The signal amplifier 434 processes these detected signals by increasing their amplitude, which is advantageous for enhancing the signal-to-noise ratio. This amplification step can sufficiently amplify low-intensity signals, which may represent fine structural or compositional details, for accurate processing and imaging. The signal amplifier 434 interfaces directly with the detectors and transmits the amplified signals to the computer controller 430 for further analysis.

Together, the computer controller 430, scan generator 432, and signal amplifier 434 enable the electron beam inspection system 400 to achieve precise control, detailed scanning, and high-resolution image formation, enhancing the tool's inspection and analytical capabilities. According to an embodiment, the electron beam inspection system 400 is configured to generate voltage contrast images, which allow the determination of the presence of defects in a semiconductor substrate 402 or semiconductor device 402. This capability is particularly advantageous for assessing the quality and reliability of semiconductor materials and components.

When utilizing the electron beam inspection system 400 to generate voltage contrast images, the electron beam 414 interacts with the sample 402 (i.e., semiconductor substrate or device). As the electron beam 414 scans the surface, the beam induces local changes in the electrical potential of the sample 402, particularly in regions where defects or inhomogeneities are present. These changes in voltage can occur due to variations in the material's doping concentration, surface charge distributions, or structural discontinuities.

The backscattering detector 422 and secondary electron detector 420 capture the backscattered and secondary electrons that provide information about the voltage contrast across the sample 402. According to an embodiment, the computer controller 430 processes the detected signals, and applies algorithms to analyze the variations in detected electron intensity corresponding to the localized voltage differences. The resulting images highlight areas of interest, such as defects, impurities, or structural anomalies, within the sample 402.

In addition, the scan generator 432 directs the electron beam 414 in a controlled manner over the surface of the sample 402, enabling detailed mapping of the voltage contrast. This scanning capability allows for high-resolution imaging, making it possible to identify even subtle defects that could affect the performance and reliability of the semiconductor device 402. Overall, the ability of the electron beam inspection system 400 to generate voltage contrast images serves as a powerful diagnostic technique for semiconductor manufacturing and quality control, facilitating the identification of defects and contributing to the development of high-performance semiconductor materials and devices.

Various types of information can be obtained by comparing two different images generated by the electron beam inspection system 400. For example, a scan image of a structure suspected to include a defect can be compared to a reference image of a similar structure that is known to be defect-free. Alternatively, first and second images, respectively captured at different electron-beam energies of the same structure suspected to contain a defect, can be compared. These two scenarios are described in detail below.

According to an embodiment, a voltage contrast image can be generated as a difference between a scanned image and a reference image, allowing for enhanced visualization of defects within a semiconductor substrate 402 or semiconductor device 402. This process involves capturing images under controlled conditions, comparing them, and analyzing the resulting differences to identify areas of interest.

Initially, a reference image is acquired using the electron beam inspection system 400 by scanning a region of the sample 402 that is known to be free of defects. Alternatively, a reference image can also be obtained from a separate sample known to be free of defects and saved for later comparison with a scan image. The reference image serves as a baseline for subsequent comparisons. During this scanning process, the electron beam 414 interacts with the sample 402, and the backscattering detector 422 and secondary electron detector 414 capture the relevant signals to create the reference image, which reflects the expected voltage distribution across a defect-free area.

Next, a scan image is obtained by scanning a region of the semiconductor substrate 402 or device 402 that is suspected to contain a defect. This scan image is generated under similar conditions to those used for the reference image to ensure comparability. The electron beam 406 interacts with the sample 402, inducing local voltage changes that arise from the presence of defects or inhomogeneities. As before, the captured signals from the backscattering detector 422 and secondary electron detector 414 are processed to create the scan image.

Once both the reference image and the scan image are obtained, the computer controller 430 processes these images to compute the voltage contrast image. This is achieved by performing a pixel-by-pixel subtraction of the reference image from the scanned image, highlighting the differences in voltage distribution. The resulting voltage contrast image emphasizes regions where voltage deviations occur, which may indicate the presence of defects, impurities, or structural anomalies within the sample 402.

Alternatively, as mentioned above, first and second images, respectively captured at different electron-beam energies of the same structure suspected to contain a defect, can be compared. In this regard, a first image is captured by scanning the sample 402 using the electron beam inspection system 400 at a predetermined first landing energy. The landing energy refers to the kinetic energy of the electrons when they interact with the surface of the semiconductor substrate 402 or device 402. At this first landing energy, the primary electron beam 406 emitted from the electron source 402 induces specific interactions with the sample material, producing a corresponding first image that reflects the voltage distribution across the scanned area. The backscattering detector 422 and secondary electron detector 414 capture the signals generated during this scan, providing detailed information about the sample 402 at this specific energy level.

Subsequently, a second image is captured by repeating the scanning process at a different, predetermined second landing energy. The change in landing energy alters the interaction dynamics between the electron beam 406 and the sample 402, allowing for the collection of additional information regarding the material's electronic and structural properties. The resulting second image contains voltage contrast information that is sensitive to the characteristics of the sample 402 at this new energy level.

After the first image and second image have been acquired, the computer controller 430 processes the images to compare and/or subtract them. This comparison can involve analyzing pixel-by-pixel differences in signal intensity, which can reveal variations in voltage distribution between the two energy levels. By subtracting the second image from the first image, regions that exhibit significant differences in voltage contrast due to defects, inhomogeneities, or other material variations become more pronounced.

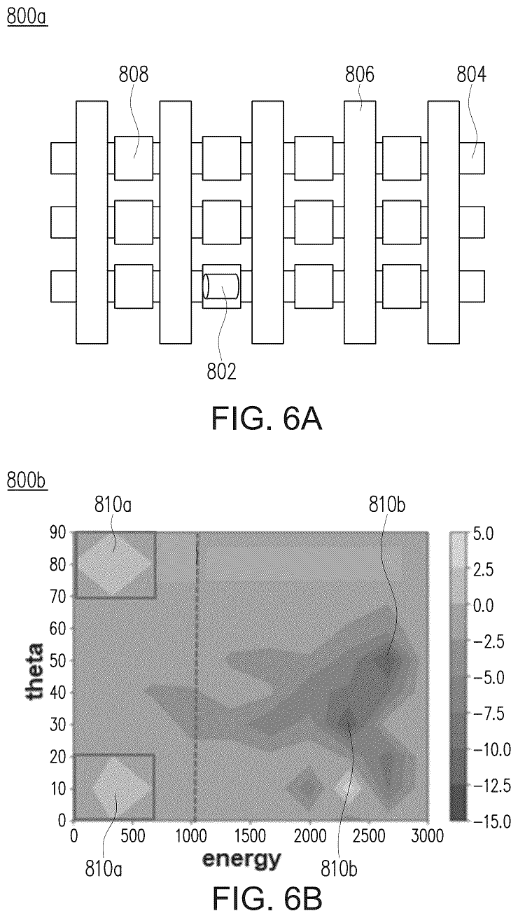

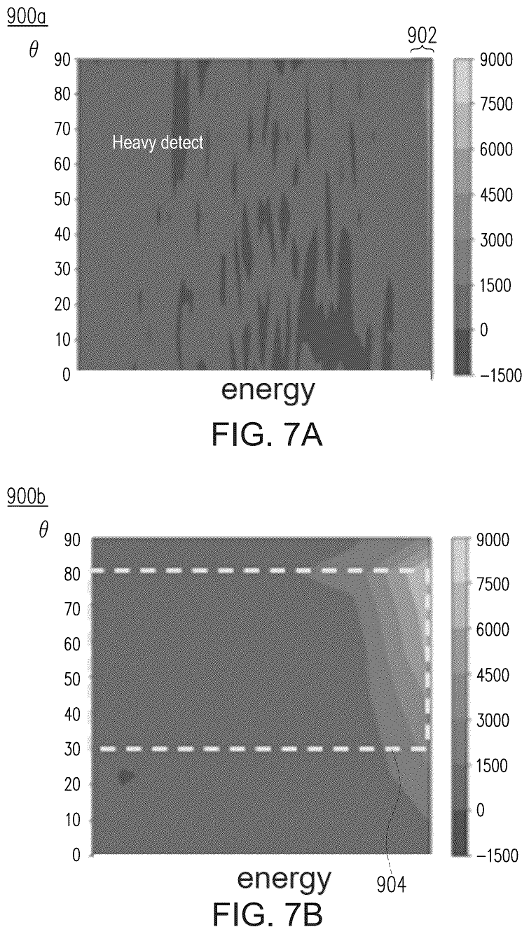

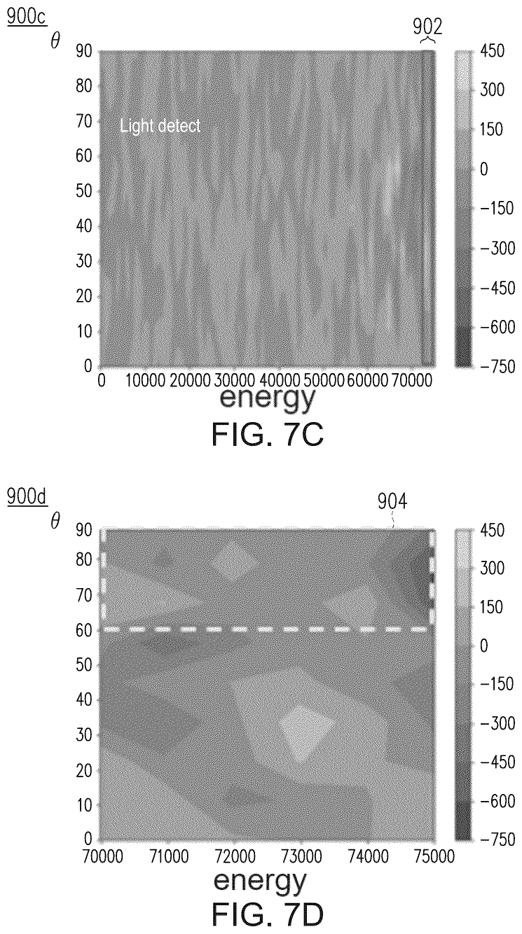

This method of capturing and comparing images at different landing energies enhances the capability of the electron beam inspection system 400 to identify defects and material variations within sample 402, contributing to improved diagnostics and quality control in semiconductor manufacturing processes. According to various embodiments, a defect that is identified within a voltage contrast image is further investigated by generating an energy-angle mapping (800a, 900a, 900b, 900c, 900d) of intensities of detected electrons from a region of the sample 402 corresponding to the suspected defect location, as described in greater detail with reference to FIGS. 6B to 7D, below. Alternatively, the process of determining a voltage contrast image can be omitted and energy-angle mappings (800a, 900a, 900b, 900c, 900d) can be determined for a plurality of locations of a sample. In this way, features revealed in the energy-angle mappings (800a, 900a, 900b, 900c, 900d) can provide information about defects in addition to, or instead of, information provided by a voltage contrast image.

FIG. 3A is an axial view of an electron detector 422a configured to determine polar incidence angles θ of detected electrons 502, and FIG. 3B is a simplified schematic view of an electron beam inspection system 400 including an electron source 404 and the electron detector 422a of FIG. 3A, according to various embodiments. Other components of the electron beam inspection system 400, such as the anode 408, condenser lenses 410, and secondary electron detector 420 are omitted for simplicity of description.

As shown in FIG. 3A, the electron detector 422a has a detector body 426 (e.g., see FIG. 2) with an annular geometry that includes a central aperture 504 configured to allow a focused electron beam 414 to pass through the detector body 426 toward the sample 402. The axial view of FIG. 3A shows a detector surface of the electron detector 422a configured to face the sample 402. The electron detector 422a includes a plurality of detection regions 506 labeled A, B, C, and D that are separated from one another along a radial direction 501. The detection regions 506 are configured as annular regions (A, B, C, D). Each of the annular regions (A, B, C, D) includes one or more detector devices (not shown explicitly) that are each configured to detect backscattered electrons 502. In this regard, each detector device is configured to generate an electrical signal in response to interaction with an electron backscattered from the sample.

As shown in FIG. 3B, each of the plurality of detection regions 506 detects backscattered electrons 502 emitted from the sample 402 at a specific range of angles θ. Thus, all the backscattered electrons 502 detected by annular region A correspond to electrons emitted from the sample 402 at approximately a first polar angle θ; the backscattered electrons 502 detected by annular region B correspond to electrons emitted from the sample 402 within a range around a second polar angle θ; the backscattered electrons 502 detected by annular region C correspond to electrons emitted from the sample 402 within a range around a third polar angle θ; and the backscattered electrons 502 detected by annular region D correspond to electrons emitted from the sample 402 within a range around a fourth polar angle θ.

Although four annular regions (A, B, C, D) are described in the example embodiment of FIGS. 3A and 3B, other embodiments are not so limited. In this regard, other embodiments include greater or fewer annular regions. As such, other embodiments have greater or lower precision in the detection of the polar angle θ. Further, the precision with which the polar angle θ that can be detected for a given detector configuration also depends on the distance d1 between the electron detector 422a and the sample 402. In this regard, the maximum value of the polar angle θ that can be detected is a function of the distance d1 between the electron detector 422a and the sample 402, and the radial distance d2 between the center of the central aperture 504 and the outermost detection region (i.e., annular region D in this example embodiment). To be precise, the maximum polar angle θₘₐₓ is given by the equation: tan(θₘₐₓ)=d2/d1. Thus, decreasing d1 and increasing d2 increases the maximum polar angle θₘₐₓ that is detectable. Similarly, the minimum polar angle θₘᵢₙ is determined by the equation: tan (θₘᵢₙ)=d3/d1, wherein d3 is the radial distance d3 between the center of the central aperture 504 and the innermost detection region (i.e., annular region A in this example embodiment). In certain embodiments, the distance d1 between the electron detector 422a and the sample 402 is between 50 microns and 2 mm, and polar angles θ can be detected in a range from about θₘᵢₙ=5 degrees to about θₘₐₓ=80 degrees.

Although not explicitly shown in FIG. 3A, each of the annular regions (A, B, C, D) includes one or more detector devices, such as semiconductor devices each generate an electrical signal when electron-hole pairs are generated by electrons impinging on the semiconductor device. For example, in some embodiments, each of the detector devices is a silicon-based photodiode, an avalanche photodiode, or a PIN diode. Various other types of detector devices are provided in other embodiments. Further, according to various embodiments, each of the detector devices is dynamically and individually selectable such that angular information of detected electrons is determined based on signals generated by selected subsets of the plurality of detector devices. In still further embodiments, electrons are detected by all of the annular regions (A, B, C, D) for a plurality of electron detection events, and then the separate signals collected from the various annular regions (A, B, C, D) are characterized based on signal processing operations that are applied to sort out the contributions from the respective annular regions (A, B, C, D)

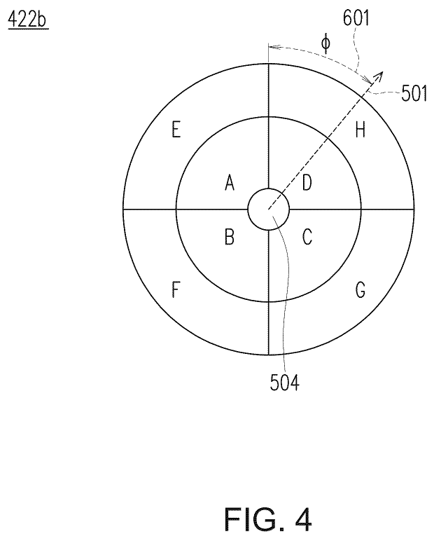

FIG. 4 is an axial view of an electron detector 422b configured to determine both polar incidence angles θ and azimuthal incidence angles φ of detected electrons, according to various embodiments. As shown, the electron detector 422b includes detector devices separated along a radial direction 501 and further separated along an azimuthal angular direction 601. For example, as shown in FIG. 4, pairs of detector devices (A, E), (B, F), (C, G), and (D, H) are respectively separated from one another along the radial direction 501. As such, these pairs of devices are used to determine a polar angle θ of detected electrons, as described above with respect to the embodiment of FIGS. 3A and 3B. In contrast to the embodiment of FIGS. 3A and 3B, however, the pairs of detectors that are separated from one another along the azimuthal angular direction 601 further allow determination of azimuthal incidence angles φ of detected electrons. For example, pairs of detector devices (A, B), (B, C), (C, D), (D, A), (E, F), (F, G), (G, H), and (H, E) are each respectively separated from one another along the azimuthal angular direction 601. Thus, the azimuthal incidence angle φ of a detected electron is determined based on the location, along the azimuthal angular direction 601, of a particular detecting device that records a signal generated by a detected electron 502.

The precision with which the azimuthal incidence angle φ is determined depends on the number of detecting devices. For example, if there are N detector devices that span the azimuthal angular direction 601, then the full range of the azimuthal incidence angles φ is divided by the number N of detector devices. More precisely, Δφ=2π/N, where Δφ is the angular uncertainty associated with the determination of φ. Thus, in the embodiment of FIG. 4, if an electron is detected by the detector device D or H, then the azimuthal incidence angle φ is known to lie within a range of 0≤φ≤π/2. Similarly, if an electron is detected by detector device A or E, then the azimuthal incidence angle φ is known to lie within a range of π/2≤φ≤π, if an electron is detected by detector device B or F, then the azimuthal incidence angle φ is known to lie within a range of π≤φ≤3π/2, and if an electron is detected by detector device C or G, then the azimuthal incidence angle φ is known to lie within a range of 3π/2≤φ≤2π. Thus, the precision of detection of the azimuthal incidence angles φ of detected electrons can be increased by increasing the number N of detector devices that are arranged along the azimuthal angular direction 601. Similarly, as described above with reference to FIGS. 3A and 3B, the precision of detection of the polar incidence angle θ can be increased by increasing the number M of detector devices arranged along the radial direction 501, as described above with reference to FIG. 3B. Although N=4 and M=2 in the embodiment of FIG. 4, other embodiments are not so limited and have greater or fewer detecting devices in respective other embodiments.

As shown in FIG. 4, a set of first detectors (A, B, C, D), located at a first radial distance from the central aperture 504 are configured to determine a first polar angle θ₁ of detected electrons, and a set of second detectors (E, F, G, H), located at a second radial distance from the central aperture 504 are configured to determine a second polar angle θ₂ of the detected electrons. Similarly, a set of first detectors (A, E) located at a first angular position relative to a reference radial line 501 are configured to determine a first azimuthal angle φ₁ of detected electrons, and second detectors (B, F) located at a second angular position relative to the reference radial line 501 are configured to determine a second azimuthal angle φ₂ of the detected electrons. In further embodiments, one or more energy filters (not shown) are included. As such, detected electrons can be filtered such that only electrons having energy within a selectable energy range are detected. As such, according to various embodiments, energy and angular information is determined by disclosed electron detectors (422a, 422b).

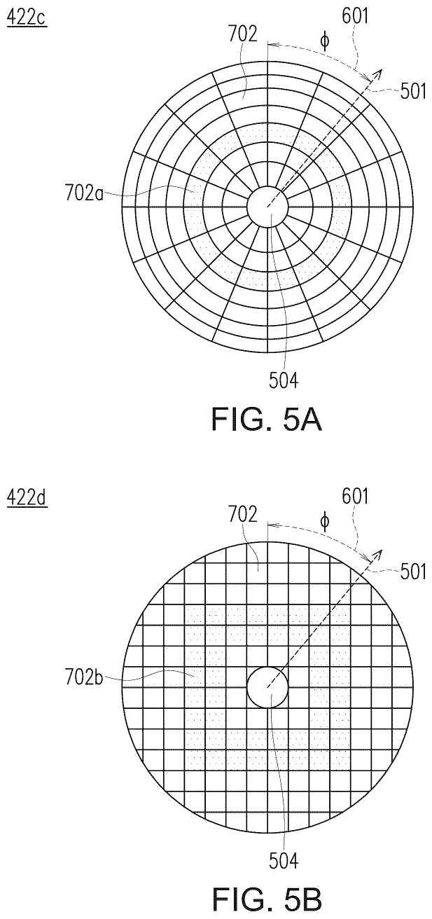

FIGS. 5A and 5B are axial views of respective electron detectors 422c and 422d configured to determine polar incidence angles θ and azimuthal incidence angles φ of detected electrons 502, according to various embodiments. As shown in FIG. 5A, the electron detector 422c includes a plurality of detector devices 702 having annular segments that are separated from one another along the radial direction 501 extending from a central aperture 504 toward an edge of the detector surface. Further, as described above with reference to FIG. 4, the detector devices 702 are arranged around the central aperture 504 along the azimuthal angular direction 601. In contrast, the electron detector 422d includes a plurality of detector devices 702 arranged in a rectangular grid spanning the detector surface around a central aperture 504.

According to various embodiments, the detector devices (422c, 422d) are configured as pixel devices that are configured to be dynamically and individually selectable such that angular information of detected electrons is determined based on signals generated by selected subsets of the plurality of detector devices. For example, in the electron detector 422c of FIG. 5A, a first plurality of selected pixel devices 702a are activated, and in the electron detector 422d of FIG. 5B, a second plurality of selected pixel devices 702b are activated. As such, signals are generated only from the selected pixel devices (702a, 702b).

For example, by activating the first plurality of selected pixel devices 702a, signals are generated corresponding to electrons detected within a range of polar angles θ, as described above with respect to FIG. 3B. In alternative configurations, different pixel devices 702a are activated along the azimuthal angular direction 601 to measure the azimuthal incidence angles φ of detected electrons. In both the electron detector 422c of FIG. 5A and the electron detector 422d of FIG. 5B, various pixel devices (702a, 702b) can be selected to generate information regarding the polar incidence angles θ and azimuthal incidence angles φ of detected electrons. For example, the second plurality of selected pixel devices 702b includes a mixture of information regarding the incidence angles θ and azimuthal incidence angles φ of detected electrons. In other words, although all the pixels in the first plurality of selected pixel devices 702a share a common value of the polar incidence angle θ, each of the first plurality of selected pixel devices 702a corresponds to a different respective value of the azimuthal incidence angle φ. In contrast, since the second plurality of selected pixel devices 702b of FIG. 5B has a rectangular grid geometry and does not have an angular symmetry, many of the second plurality of selected pixel devices 702b have dissimilar values of the polar incidence angle θ and azimuthal incidence angle φ. The ability to selectively choose the detecting pixel devices allows considerable freedom in controlling specific ranges of polar incidence angle θ and azimuthal incidence angle φ as needed for a wide range of applications.

As described above, according to various embodiments, the electron detectors (422a, 422b, 422c, 422d) are further provided with energy filtering devices (not shown) that filter electrons such that only electrons within a selected range of energies are detected. According to various embodiments, such energy filters are configured to be controlled at a pixel-by-pixel level and are implemented to be dynamically and individually selectable such that only electrons within a selected energy range are detected. As such, according to various embodiments, the electron detectors (422a, 422b, 422c, 422d) are configured to generate an energy-angle mapping (800b, 900a, 900b, 900c, 900d) of intensities of detected electrons, as described in greater detail with reference to FIGS. 6A to 7D, below.

FIG. 6A is a top view of a semiconductor structure 800a having a defect 802, and FIG. 6B is an energy-angle mapping 800b of intensities of detected backscattered electrons 502 associated with the defect 802, according to various embodiments. In this example, the semiconductor structure 800a is a structure that includes a plurality of gate-all-around (GAA) semiconductor transistors including a plurality of semiconductor fin structures 804 and a plurality of wrap-around gate 806 structures. Source/drain epitaxial layers 808 are formed over the plurality of semiconductor fin structures 804 on opposite sides of each gate 806 structure. In this example, one of the source/drain epitaxial layers 808 includes a defect 802, which is formed as a void in the epitaxial layer 808. The presence of the defect 802 is found by capturing images of the semiconductor structure 800a using the electron beam inspection system 400 or by generating energy-angle mappings 800b. In this regard, scanning images, such as voltage contrast images reveal the presence of some defects that are not too deep below the surface of the semiconductor structure 800a. For some deep defects, however, it may be difficult to locate the defect 802 based on scanning images of secondary electrons. The disclosed embodiments, which include the determination of an energy-angle mapping of (higher energy) backscattered electrons, provide greater accuracy in the detection of deep defects that may be otherwise missed in scanning images of secondary electrons alone.

Electron detectors (422a, 422b, 422c, 422d) are configured to detect deep defects by providing the ability to generate an energy-angle mapping 800b of intensities of detected backscattered electrons 502. In this regard, certain defects have distinct signatures that only appear in an energy-angle mapping 800b such as the one shown in FIG. 6B. The energy-angle mapping 800b in FIG. 6B was generated by performing numerical simulations of electron scattering processes. In this regard, the defect 802 was modeled as a cylindrical void having a 9 nm radius placed horizontally within one of the source/drain epitaxial layers 808 such that the cylindrical center is placed at a depth of 19 nm from a top surface of the source/drain epitaxial layer 808. The numerical simulations are based on varying the energy of the incident electron beam 414 and calculating the energy and angles (θ, φ) of backscattered electrons 502.

The numerical simulations are performed using an open-source software package that uses the Monte Carlo method and implements electron Mott scattering theory for backscattering events, dielectric function theory for secondary electron events, and quantum mechanical theory for boundary-crossing events. The energy-angle mapping 800b is generated by subtracting intensities of backscattered electrons 502 simulated for the semiconductor structure 800a including the defect 802, and from similar intensities simulated for a reference semiconductor structure (i.e., similar to the semiconductor structure 800a) that does not include the defect. Backscattering electron energies were computed in a range from about 0 V to about 3 kV for backscattered electrons 502 having polar angle θ in a range from about 0 degrees to about 90 degrees from vertical backscattering direction (e.g., see FIG. 3B). The energy-angle mapping 800b is a plot of intensity differences having a magnitude that is greater than a predetermined threshold. The sign of the intensity differences is indicated by the scale on the right side of FIG. 6B.

As shown in FIG. 6B, the energy-angle mapping 800b includes first features 810a at low energies and second features 810b at higher energies. In this regard, the energy-angle mapping 800b shows considerable structure in localized regions 810b at energies greater than 1 kV and within a range of polar angles between about 10 degrees and 60 degrees. These results indicate that the energy-angle mapping 800b includes a significant amount of information about the defect 802 that would not be captured if scanned images of the semiconductor structure 800a were generated within a limited range of backscattering energies and angles.

FIGS. 7A to 7D are energy-angle mappings (900a, 900b, 900c, 900d) of intensities of backscattered electrons 502 from various defects, according to various embodiments. The energy-angle mappings (900a, 900b) correspond to numerical simulations performed for light defects (e.g., voids) and the energy-angle mappings (900c, 900d) correspond to numerical simulations performed for heavy defects (e.g., inclusions having greater mass/density than the surrounding material). Each of the energy-angle mappings (900a, 900c) corresponds to a backscattered electron energy range from about 0 V to about 75 kV, and each of the energy-angle mappings (900b, 900d) corresponds are a magnified view showing energies from about 70 kV to about 75 kV. In this regard, the magnified views of FIGS. 7B and 7D correspond to the limited range 902 of FIGS. 7A and 7C. As shown, for certain deep defects, the energy-angle mappings (900b, 900d) of FIGS. 7B and 7D reveal significant structure (see dashed regions 904) at relatively higher energies and polar incidence angles θ.

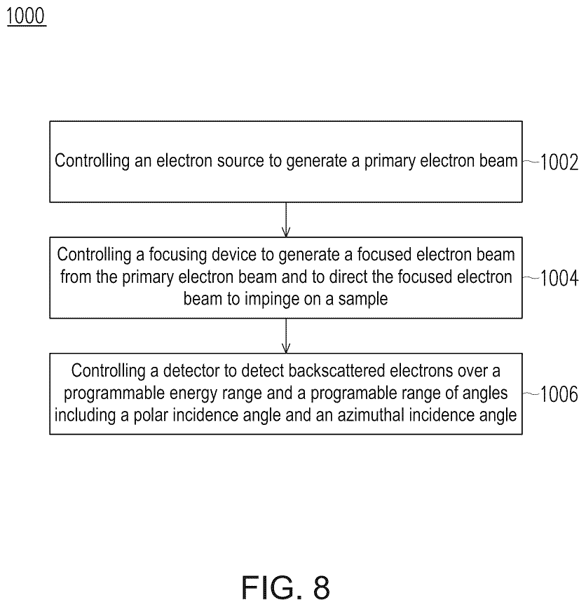

FIG. 8 is a flowchart illustrating operations of a computer-implemented method 1000 of controlling a defect detection system 400, according to various embodiments. According to various embodiments, the method 1000 is encoded as computer program instructions stored on a non-transitory computer-readable storage medium that, when executed by a processor of a controller device (430, 432, 434), cause the controller device (430, 432, 434) to perform various operations (1002, 1004, 1006) of the method 1000. According to operation 1002, the method 1000 includes controlling an electron source 404 to generate a primary electron beam 406. According to operation 1004, the method 1000 includes controlling a focusing device (410, 412) to generate a focused electron beam 414 from the primary electron beam 406 and to direct the focused electron beam 414 to impinge on a sample 402. According to operation 1006, the method 1000 includes controlling a detector (422, 422a, 422b, 422c, 422d) to detect backscattered electrons 502 over a programmable energy range and a programable range of angles (θ, φ) including a polar incidence angle θ and an azimuthal incidence angle φ (see FIGS. 6B to 7D).

According to various embodiments, the non-transitory computer-readable storage medium includes additional computer program instructions that, when executed by the processor of the controller device (430, 432, 434), cause the controller device (430, 432, 434) to perform additional operations. Such additional operations include controlling a plurality of detector devices (A to H, 702) that are dynamically and individually selectable such that a subset of the plurality of detector devices (702a, 702b) is selected; controlling the subset of the plurality of detector devices (702a, 702b) to detect electrons 502 backscattered from the sample 402; and determining the azimuthal incidence angle φ and the polar incidence angle θ of an electron trajectory based on locations of the subset of the plurality of detector devices (702a, 702b).

According to various embodiments, the non-transitory computer-readable storage medium includes additional computer program instructions that, when executed by the processor of the controller device (430, 432, 434), cause the controller device (430, 432, 434) to perform additional operations. Such additional operations include determining the polar incidence angle θ of the electron trajectory based on a radial location of a selected one of the plurality of detector devices 702a and determining the azimuthal incidence angle φ of the electron trajectory based on an angular location of the selected one of the plurality of detector devices 702a.

According to various embodiments, the non-transitory computer-readable storage medium includes additional computer program instructions that, when executed by the processor of the controller device (430, 432, 434), cause the controller device (430, 432, 434) to perform additional operations. Such additional operations include generating an energy-angle mapping (800b, 900a, 900b, 900c, 900d) of intensities of detected electrons 502; determining intensity differences in localized regions (810a, 810b, 902, 904) of the energy-angle mapping (800b, 900a, 900b, 900c, 900d) comprising the intensity differences having a magnitude that is greater than a predetermined threshold; and determining a correspondence between a specific defect type 802 and a corresponding pattern of the localized regions (810a, 810b) of the energy-angle mapping (800b, 900a, 900b, 900c, 900d).

Referring to all drawings and according to various embodiments of the present disclosure, a defect detection system 400 is provided. The defect detection system 400 includes an electron source 404 configured to generate a primary electron beam 406, a focusing device (410, 412) configured to focus the primary electron beam 406 to generate a focused electron beam 414 and to direct the focused electron beam 414 to imping on a sample 402, a stage 418 configured to hold the sample 402 while the focused electron beam 414 impinges on the sample 402, and a detector (422, 422a, 422b, 422c, 422d) configured to detect backscattered electrons 502 over a programmable energy range and a programable range of angles (θ, φ) including a polar incidence angle θ and an azimuthal incidence angle φ.

According to various embodiments, the detector (422, 422a, 422b, 422c, 422d) further includes a plurality of detector devices (A to H, 702) located on a detector surface (see FIGS. 3A, 4, 5A, 5B) that faces the sample 402, and the plurality of detector devices 702 are pixel devices arranged in a rectangular grid spanning the detector surface (see FIG. 3B). According to various embodiments, the detector (422, 422a, 422b, 422c, 422d) further a plurality of detector devices (A to H, 702) located on a detector surface (see FIGS. 3A, 4, 5A, 5B) that faces the sample 402, and the plurality of detector devices 702 are pixel devices comprising annular segments separated from one another along a radial direction 501 extending from a center toward an edge of the detector surface (see FIG. 5A).

According to various embodiments, the defect detection system 400 further includes a plurality of detector devices (A to H, 702) arranged along radial directions 501 of a detector surface (see FIGS. 3A, 4, 5A, 5B) that are configured to determine the polar incidence angle θ to be between about 5 degrees to about 80 degrees. According to various embodiments, defect detection system 400 further includes a plurality of detector devices (A to H, 702) that are dynamically and individually selectable such that angular information of detected electrons 502 is determined based on signals generated by selected subsets (702a, 702b) of the plurality of detector devices (A to H, 702).

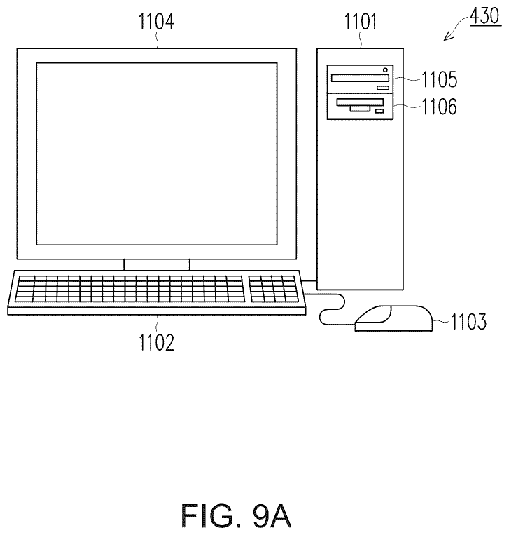

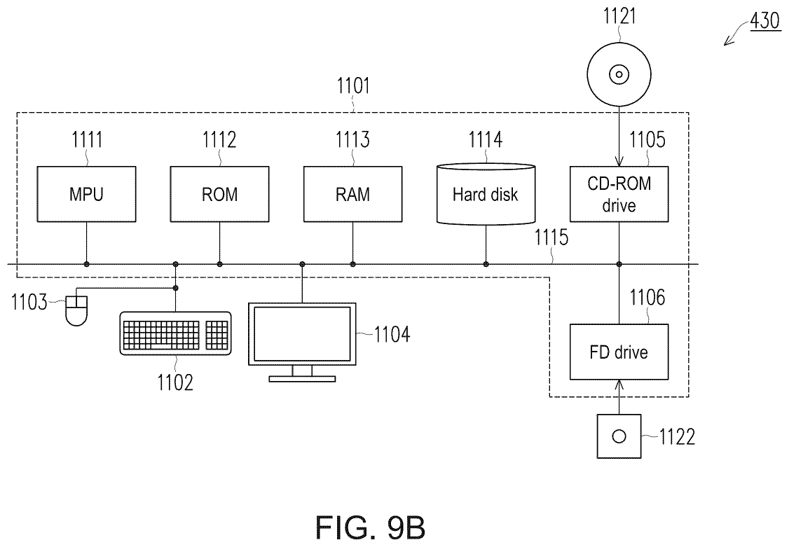

FIGS. 9A and 9B illustrate a computer controller 430 configured to perform the method 1000 of FIG. 8, according to various embodiments. FIG. 9A is a schematic view of a computer system that is used to control a defect detection system according to one or more embodiments as described above. All of or a part of the processes, methods, and/or operations of the above-described embodiments can be realized using computer hardware and computer programs executed thereon. In FIG. 9A, a computer system 1100 is provided with a computer 1101 including an optical disk read-only memory (e.g., CD-ROM or DVD-ROM) drive 1105 and a magnetic disk drive 1106, a keyboard 1102, a mouse 1103, and a monitor 1104.

FIG. 9B is a diagram showing an internal configuration of the computer system 1100. The computer 1101 is provided with, in addition to the optical disk drive 1105 and the magnetic disk drive 1106, one or more processors 1111, such as a micro processing unit (MPU), a read-only memory (ROM) 1112 in which a program, such as a boot-up program is stored, a random access memory (RAM) 1113 that is connected to the MPU 1111 and in which a command of an application program is temporarily stored and a temporary storage area is provided, a hard disk 1114 in which an application program, a system program, and data are stored, and a bus 1115 that connects the MPU 1111, the ROM 1112, and the like. Note that the computer 1101 may include a network card (not shown) for providing a connection to a LAN.

Computer program instructions, configured to cause the computer system 1100 to execute the method 1000 are stored in a non-transitory computer-readable storage medium, such as an optical disk 1121 or a magnetic disk 1122. Such a storage medium is configured to be inserted into the optical disk drive 1105 or the magnetic disk drive 1106, and transmitted to the hard disk 1114. Alternatively, the program may be transmitted via a network (not shown) to the computer 1101 and stored in the hard disk 1114 (or other non-transitory computer-readable storage medium). At the time of execution, the program is loaded into the RAM 1113. The program may be loaded from the optical disk 1121 or the magnetic disk 1122, or directly from a network. The program does not necessarily need to include, for example, an operating system (OS) or a third-party program to cause the computer 1101 to execute the process for manufacturing the lithographic mask of a semiconductor device in the foregoing embodiments. The program may only include a command portion to call an appropriate function (module) in a controlled mode and obtain desired results.

Disclosed embodiments are advantageous by providing systems 400 and methods 1000 of detecting backscattered electrons 502 with energy and angular resolution such that both polar incidence angles θ and azimuthal incidence angles φ of backscattered electrons 502 are determined. Such systems 400 provide the ability to generate energy-angle mappings (800b, 900a, 900b, 900c, 900d) that include localized features (810a, 810b, 902, 904) that are characteristic of particular types of defects 802. Thus, embodiment systems 400 and methods 1000 provide information that complements information available from electron-beam inspection systems that operate only in narrow ranges of energy and angular resolution. Numerical simulation results (FIGS. 6B and 7A to 7D) indicate that such energy-angle mappings (800b, 900a, 900b, 900c, 900d) can provide useful information about deep defects 802.

According to various embodiments, an electron detector is provided. The electron detector includes a detector body having a detector surface that has an annular geometry and a central aperture configured to allow a focused electron beam to pass through the detector body toward a sample, wherein the detector surface is configured to face the sample, and a plurality of detector devices located on the detector surface, wherein each of the plurality of detector devices is configured to generate an electrical signal in response to interaction with an electron backscattered from the sample. According to various embodiments, the plurality of detector devices includes at least a first two detector devices separated from one another along a radial direction along the detector surface and at least a second two detector devices separated from one another along an angular direction along the detector surface.

According to various embodiments, the plurality of detector devices are pixel devices arranged in a rectangular grid spanning the detector surface. According to various embodiments, the plurality of detector devices are pixel devices including annular segments separated from one another along the radial direction extending from the central aperture toward an edge of the detector surface. According to various embodiments, each of the plurality of detector devices is a semiconductor device that generates the electrical signal when electron-hole pairs are generated when electrons impinge on the semiconductor device. According to various embodiments, each of the plurality of detector devices is a silicon-based photodiode, an avalanche photodiode, or a PIN diode. According to various embodiments, a spatial arrangement of the plurality of detector devices is configured to provide angular information regarding a trajectory of detected electrons in terms of both a polar incidence angle and an azimuthal incidence angle.

According to various embodiments, the plurality of detector devices include detector devices arranged along radial directions of the detector surface and configured to determine a polar incidence angle that is between about 5 degrees to about 80 degrees. According to various embodiments, the plurality of detector devices are dynamically and individually selectable such that angular information of detected electrons is determined based on signals generated by selected subsets of the plurality of detector devices. According to various embodiments, the plurality of detector devices are dynamically and individually selectable such that only electrons within a selected energy range are detected.

According to various embodiments, first detectors located at a first radial distance from the central aperture are configured to determine a first polar angle of detected electrons, and second detectors located at a second radial distance from the central aperture are configured to determine a second polar angle of the detected electrons. According to various embodiments, first detectors located at a first angular position relative to a reference radial line are configured to determine a first azimuthal angle of detected electrons and second detectors located at a second angular position relative to the reference radial line are configured to determine a second azimuthal angle of the detected electrons.

According to various embodiments, a defect detection system is provided. The defect detection system includes an electron source configured to generate a primary electron beam, a focusing device configured to focus the primary electron beam to generate a focused electron beam and to direct the focused electron beam to impinge on a sample, a stage configured to hold the sample while the focused electron beam impinges on the sample, and a detector configured to detect backscattered electrons over a programmable energy range and a programable range of angles including a polar incidence angle and an azimuthal incidence angle.

According to various embodiments, the detector includes a plurality of detector devices located on a detector surface that faces the sample, and the plurality of detector devices are pixel devices arranged in a rectangular grid spanning the detector surface. According to various embodiments, the detector includes a plurality of detector devices located on a detector surface that faces the sample, and the plurality of detector devices are pixel devices including annular segments separated from one another along a radial direction extending from a center toward an edge of the detector surface.

According to various embodiments, a defect detection system further includes a plurality of detector devices arranged along radial directions of a detector surface and configured to determine the polar incidence angle to be between about 5 degrees to about 80 degrees. According to various embodiments, the plurality of detector devices that are dynamically and individually selectable such that angular information of detected electrons is determined based on signals generated by selected subsets of the plurality of detector devices.

According to various embodiments, a non-transitory computer-readable storage medium having computer program instructions stored thereon is provided. The computer program instructions are encoded such that when executed by a processor of a controller device, they cause the controller device to perform operations including controlling an electron source to generate a primary electron beam; controlling a focusing device to generate a focused electron beam from the primary electron beam and to direct the focused electron beam to impinge on a sample and controlling a detector to detect backscattered electrons over a programmable energy range and a programable range of angles including a polar incidence angle and an azimuthal incidence angle.

According to various embodiments, the non-transitory computer-readable storage medium includes additional computer program instructions that, when executed by the processor of the controller device, cause the controller device to perform additional operations including: controlling a plurality of detector devices that are dynamically and individually selectable such that a subset of the plurality of detector devices is selected; controlling the subset of the plurality of detector devices to detect electrons backscattered from the sample; and determining the azimuthal incidence angle and the polar incidence angle of an electron trajectory based on locations of the subset of the plurality of detector devices.

According to various embodiments, the non-transitory computer-readable storage medium includes additional computer program instructions that, when executed by the processor of the controller device, cause the controller device to perform additional operations including determining the polar incidence angle of the electron trajectory based on a radial location of a selected one of the plurality of detector devices; and determining the azimuthal incidence angle of the electron trajectory based on an angular location of the selected one of the plurality of detector devices.

According to various embodiments, the non-transitory computer-readable storage medium includes additional computer program instructions that, when executed by the processor of the controller device, cause the controller device to perform additional operations including generating an energy-angle mapping of intensities of detected electrons, determining intensity differences in localized regions of the energy-angle mapping including the intensity differences having a magnitude that is greater than a predetermined threshold, and determining a correspondence between a specific defect type and a corresponding pattern of the localized regions of the energy-angle mapping.

The foregoing outlines features of several embodiments or examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments or examples introduced herein. Those skilled in the art should also realize that such equivalent constructions do not depart from the spirit and scope of the present disclosure and that they may make various changes, substitutions, and alterations herein without departing from the spirit and scope of the present disclosure.

What is claimed is:

1. A method of configuring a defect detection system, the method comprising:
configuring a controller to be communicatively coupled to an electron source and a focusing device; and
programming the controller to perform operations comprising:
controlling the electron source to generate a primary electron beam;
controlling the focusing device to generate a focused electron beam from the primary electron beam and to direct the focused electron beam to impinge on a sample; and
generating an energy-angle mapping of intensities of detected backscattered electrons from the sample.

2. The method of claim 1, further comprising programming the controller to perform further operations comprising:
determining a correspondence between a specific defect type and a pattern of localized regions within the energy-angle mapping where intensity differences have a magnitude greater than a threshold.

3. The method of claim 1, further comprising communicatively coupling the controller to a detector comprising a plurality of pixel devices arranged in annular segments.

4. The method of claim 3, further comprising:
configuring the annular segments to be separated from one another along a radial direction.

5. The method of claim 3, further comprising programming the controller to perform further operations comprising:
dynamically selecting a subset of the plurality of pixel devices to be active for detecting the detected backscattered electrons.

6. The method of claim 5, wherein dynamically selecting the subset comprises:
selecting the subset based on a target programmable energy range.

7. The method of claim 1, further comprising programming the controller to perform further operations comprising:
determining an azimuthal incidence angle and a polar incidence angle for the detected backscattered electrons.

8. A non-transitory computer-readable storage medium comprising computer program instructions stored thereon that, when executed by a processor, cause the processor to perform operations comprising:
controlling an electron source to generate a primary electron beam and a focusing device to direct a focused electron beam onto a sample;
dynamically selecting a subset of detector devices from a plurality of detector devices;
controlling the subset of detector devices to detect electrons backscattered from the sample; and
determining an azimuthal incidence angle φ and a polar incidence angle θ of an electron trajectory based on locations of the subset of detector devices.

9. The non-transitory computer-readable storage medium of claim 8, wherein:
the plurality of detector devices comprises pixel devices located on a detector surface facing the sample; and
the computer program instructions, when executed by the processor, cause the processor to perform further operations comprising individually accessing detection data received from each of the pixel devices.

10. The non-transitory computer-readable storage medium of claim 9, wherein:
the pixel devices are arranged in annular segments; and
the computer program instructions, when executed by the processor, cause the processor to perform further operations comprising mapping the detection data to a corresponding polar collection angle based on which of the annular segments detected the electrons backscattered from the sample.

11. The non-transitory computer-readable storage medium of claim 10, wherein:
the annular segments are separated from one another along a radial direction; and
the computer program instructions, when executed by the processor, cause the processor to perform operations further comprising varying a radial detection sensitivity threshold across different ones of the annular segments.

12. The non-transitory computer-readable storage medium of claim 8, wherein the computer program instructions, when executed by the processor, cause the processor to perform further operations comprising generating an energy-angle mapping of intensities of the electrons backscattered from the sample.

13. The non-transitory computer-readable storage medium of claim 12, wherein the operations further comprise:
determining a specific defect type based on a pattern of localized regions within the energy-angle mapping.

14. The non-transitory computer-readable storage medium of claim 8, wherein dynamically selecting the subset of detector devices comprises:
performing selection on an individual device basis.

15. An electron detector, comprising:
a detector body having an annular geometry and a central aperture configured to allow a focused electron beam to pass therethrough;
a first set of detector devices located at a first radial distance from the central aperture and configured to determine a first polar angle θ₁ of detected electrons; and
a second set of detector devices located at a second radial distance from the central aperture and configured to determine a second polar angle θ₂ of the detected electrons, the second radial distance being different from the first radial distance.

16. The electron detector of claim 15, wherein the first set of detector devices and the second set of detector devices comprise pixel devices.

17. The electron detector of claim 16, wherein the pixel devices are arranged in annular segments.

18. The electron detector of claim 15, further comprising:
a third set of detector devices separated from another set of detector devices along an azimuthal angular direction,
wherein the third set of detector devices is configured to determine a first azimuthal angle of the detected electrons.

19. The electron detector of claim 15, further comprising a controller configured to perform operations comprising:
dynamically and individually selecting a subset of devices from among the first set of detector devices and the second set of detector devices.

20. The electron detector of claim 15, wherein:
the detector body comprises a detector surface configured to face a sample, and
the first set of detector devices and the second set of detector devices are disposed on the detector surface.
